(19) United States
(12) Patent Application Publication
(10) Pub. No.: US 2021/0212377 A1
(43) Pub. Date: Jul. 15, 2021

(54) AIRFLOW SWITCH BATTERY

(71) Applicant: Shenzhen Eigate Technology Co., Ltd., Shenzhen (CN)

(72) Inventor: Tuanfang LIU, Shenzhen (CN)

(21) Appl. No.: 17/020,795

(22) Filed: Sep. 14, 2020

(30) Foreign Application Priority Data
Jan. 15, 2020 (CN) 202020088928.0

(51) Int. Cl. A24F 40/51; A24F 40/90; H01M 2/10; H01M 10/42; H02J 7/00

(52) U.S. Cl. CPC A24F 40/51; A24F 40/90; H01M 2220/30; H01M 10/4257; H02J 7/0045; H01M 2/1055

(57) ABSTRACT

An airflow switch battery, including a joint, a cell, a battery rod, and a pneumatic switch. The joint is hollow and disposed on the top end of the battery. The air flow enters the battery from a charging port disposed on the bottom end of the battery and is discharged from the hollow part of the joint. The joint is electrically conductive and allows the current to pass through. The cell is disposed in the battery rod. An internal air passage is formed between the outer wall of the cell and the inner wall of the battery rod to allow the air flow to pass through. When the air flow passes through the pneumatic switch, the circuit of the airflow switch battery is connected so that the pneumatic switch functions as a battery switch.

### CROSS-REFERENCE TO RELATED APPLICATIONS

Pursuant to 35 U.S.C.§ 119 and the Paris Convention Treaty, this application claims foreign priority to Chinese Patent Application No, 202020088928.0 filed Jan. 15, 2020, the contents of which, including any intervening amendments thereto, are incorporated herein by reference. Inquiries from the public to applicants or assignees concerning this document or the related applications should be directed to: Matthias Scholl P.C., Attn.: Dr, Matthias Scholl Esq,, 245 First Street, 18th Floor, Cambridge, Mass. 02142.

### BACKGROUND

The disclosure relates to an airflow switch battery.

The surface of a conventional battery for electronic cigarettes is provided with one or more air vents, which may be unexpectedly blocked by users' fingers when inhaling.

### SUMMARY

The disclosure provides an airflow switch battery, comprising a joint, a cell, a battery rod and a pneumatic switch. The joint is hollow and disposed on the top end of the battery; an air flow enters the battery from a charging port disposed on the bottom end of the battery and is discharged from the hollow part of the joint. The joint is electrically conductive and allows a current to pass through. The cell is disposed in the battery rod; an internal air passage is formed between the outer wall of the cell and the inner wall of the battery rod to allow the air flow to pass through; when the air flow passes through the pneumatic switch, the circuit of the airflow switch battery is connected so that the pneumatic switch functions as a battery switch.

The airflow switch battery further comprises a control panel; the cell comprises an output end soldered on an input end of the control panel; the pneumatic switch is soldered on the control panel; when the air flow passes through the pneumatic switch, a circuit of the control panel is connected.

The airflow switch battery further comprises a support; the control panel is disposed on the support to fix the control panel and a USB port on the control panel.

The airflow switch battery further comprises a silicone sleeve disposed around the pneumatic switch to protect the pneumatic switch.

The airflow switch battery further comprises a copper threaded ring and an insulation ring; the joint is disposed in the insulation ring for air conduction and electric conduction; the insulation ring is disposed in the copper threaded ring; the copper threaded ring is disposed on a top end of the battery rod.

The airflow switch battery further comprises a first ethylene-vinyl acetate (EVA) gasket and a second EVA gasket respectively disposed on two ends of the battery.

The airflow switch battery further comprises a bottom cover; the charging port is disposed on the bottom cover and aligns with the USB port; and the bottom cover is disposed on a bottom cud of the battery rod.

With the aforesaid technical solutions, when the air flow passes through the pneumatic switch, the circuit of the control panel is connected and the cell supplies power for the control panel. The joint is hollow and disposed on the top end of the battery. The air flow enters the battery from a charging port disposed on the bottom end of the battery and is discharged from a hollow part of the joint; the joint is electrically conductive and allows the current to pass through.

### BRIEF DESCRIPTION OF THE DRAWINGS

FIG.1 is an exploded view of an airflow switch battery according to one embodiment of the disclosure;

FIG. 2 is a schematic diagram of an airflow switch battery according to one embodiment of the disclosure: and

FIG. 3 is a sectional view of an airflow switch battery according to one embodiment of the disclosure.

### DETAILED DESCRIPTION

To further illustrate, embodiments detailing an airflow switch battery are described below. It should be noted that the following embodiments are intended to describe and not to limit the disclosure.

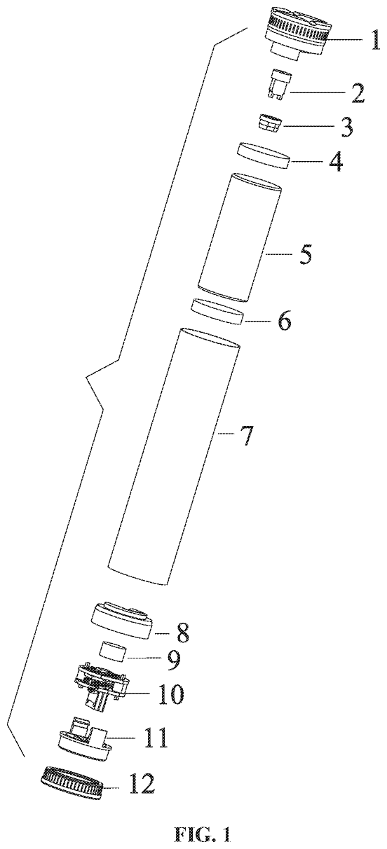

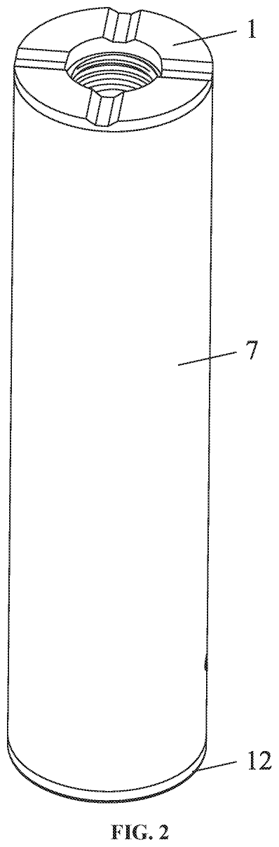

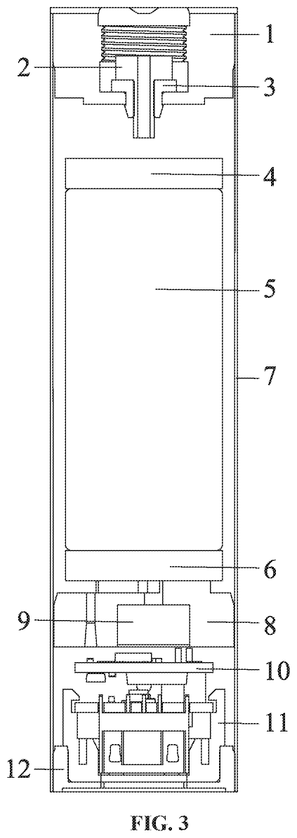

As shown in FIGS. 1-3, the disclosure provides an airflow switch battery, comprising a copper threaded ring 1, a joint 2, an insulation ring 3, a first ethylene-vinyl acetate (EVA) gasket 4, a cell 5, a second EVA gasket 6, a battery rod 7, a silicone sleeve 8, a pneumatic switch 9, a control panel 10, a support 11 and a bottom cover 12. The insulation ring 3 is disposed in the copper threaded ring 1. The joint 2 is disposed in the insulation ring 3. The cell 5 comprises an output end soldered on an input end of the control panel 10; the pneumatic switch 9 is soldered on the control panel 10; when the air flow passes through the pneumatic switch 9, the circuit of the control panel is connected. The silicone sleeve 8 disposed around the pneumatic switch 9 to protect the pneumatic switch 9. The first ethylene-vinyl acetate (EVA) gasket 4 and the second EVA gasket 6 respectively disposed on two ends of the battery 5. The control panel 10 is disposed on the support 11 to fix the control panel and the USB port on the control panel. The support 11 is fixed on the bottom cover 12. The charging port is disposed on the bottom cover 12 and aligns with the USB port of the control panel; and the bottom cover 12 is disposed on the bottom end of the battery rod 7.

The following advantages are associated with the airflow switch battery of disclosure:

1. The top and bottom of the battery are provided with a straight air passage which can trigger the pneumatic switch to work, so as to prevent the users' hand from blocking the air hole when inhaling.

2. The USB charging port is disposed on the bottom of the battery for ventilation and charging the battery.

It will be obvious to those skilled in the art that changes and modifications may be made, and therefore, the aim in the appended claims is to cover all such changes and modifications.

What is claimed is:

1. An airflow switch battery, comprising a joint, a cell, a battery rod, and a. pneumatic switch; wherein the joint is hollow and disposed on a top end of the battery; an air flow enters the battery from a charging port disposed on a bottom end of the battery and is discharged from a hollow part of the joint; the joint is electrically conductive and allows a current to pass through; the cell is disposed in the battery rod; an internal air passage is formed between an outer wall of the cell and an inner wall of the battery rod to allow the air flow to pass through; when the air flow passes through the pneumatic switch, a circuit of the airflow switch battery is connected so that the pneumatic switch functions as a battery switch.

2. The airflow switch battery of claim 1, further comprising a control panel; wherein the cell comprises an output end soldered on an input end of the control panel; the pneumatic switch is soldered on the control panel; when the air flow passes through the pneumatic switch, a circuit of the control panel is connected.

3. The airflow switch battery of claim 2, further comprising a support; wherein the control panel is disposed on the support to fix the control panel and a USB port on the control panel.

4. The airflow switch battery of claim 3, further comprising a silicone sleeve disposed around the pneumatic switch to protect the pneumatic switch.

5. The airflow switch battery of claim 3, further comprising a copper threaded ring and an insulation ring; wherein the joint is disposed in the insulation ring for air conduction and electric conduction; the insulation ring is disposed in the copper threaded ring; the copper threaded ring is disposed on a top end of the battery rod.

6. The airflow switch battery of claim 5, further comprising a first ethylene-vinyl acetate (EVA) gasket and a second EVA gasket respectively disposed on two ends of the battery.

7. The airflow switch battery of claim 6, further comprising a bottom cover; wherein the charging port is disposed on the bottom cover and aligns with the USB port;
and the bottom cover is disposed on a bottom end of the battery rod.
